(19) United States
(12) Patent Application Publication
(10) Pub. No.: US 2006/0090948 A1
(43) Pub. Date: May 4, 2006

(54) Driver side airbag detainment and containment device

(76) Inventor: Gregory Thurman Allen, Springville, AL (US)

Correspondence Address: Greg Allen, P.O. Box 416, Springville, AL, 35146, US

(21) Appl. No.: 11/250,444

(22) Filed: Oct. 17, 2005

Related U.S. Application Data
(60) Provisional application No. 60/620,017, filed on Oct. 18, 2004.

(51) Int. Cl. B60R 21/00

(52) U.S. Cl. 180/271

(57) ABSTRACT

A device that insures peace of mind from steering wheel airbags deploying on First Responders after being installed. A device that weighs less than two pounds. My device is made of the strongest fabrics known and has a lock down strap built in that requires only one person to install in seconds. All you do is slip the device over the steering wheel and cinch down strap securing it to the steering wheel.

### BACKGROUND OF INVENTION

Driver side airbags have been known to go off after accidents and injure occupants that were in front or near them. First Responders put their lives and well being at risk when they enter a vehicle where the driver's airbag has not deployed. By installing this device the rescuers can remove the fear and better do his job.

### BRIEF DESCRIPTION OF THE DRAWINGS

FIG. 1—Face of the device is solid in mass to detain and contain with reinforcing straps sewn in with buckle and cinched strap.

FIG. 2—shows rear of device with straps and buckle sewn in and stitching

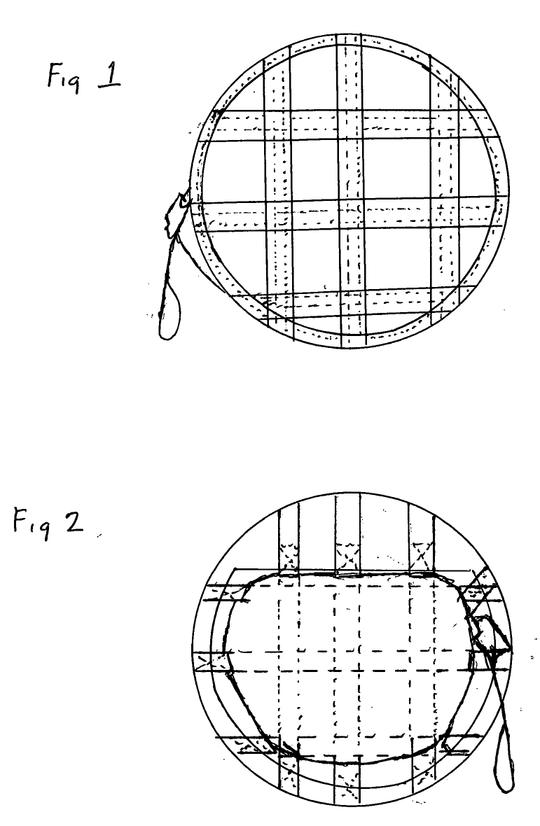

1. What I claim as my invention is a device that when installed over the steering wheel protects the person in front of the steering wheel from serious injury or even death. The device has been made using the strongest fabrics known and sewn with high tested threads. It only takes one person to install and weighs less than two pounds. It has been designed for many airbag deployments.
